(19) United States
(12) Patent Application Publication
(10) Pub. No.: US 2015/0363765 A1
(43) Pub. Date: Dec. 17, 2015

(54) METHOD AND SYSTEM FOR MANAGING A DEVICE WITH A SECURE ELEMENT USED AS A PAYMENT TERMINAL

(71) Applicant: Mobeewave Inc., Montreal (CA)

(72) Inventors: Vincent ALIMI, Verdun (CA); Sebastien FONTAINE, Montreal (CA); Xavier ALBERTI, Montreal (CA); Benjamin DU HAYS, Hampstead (CA); Maxime DE NANCLAS, Montreal (CA)

(21) Appl. No.: 14/305,426

(22) Filed: Jun. 16, 2014

(51) Int. Cl. G06Q 20/32

(52) U.S. Cl. CPC G06Q 20/3227

(57) ABSTRACT

The present disclosure relates to a method and a terminal management system for managing a device used as a payment terminal and comprising a secure element. The method comprises generating a profile of the payment terminal on the terminal management system, based on a specific execution environment of the payment terminal. The method also comprises uploading a payment acceptance applet on the secure element of the device. The method further comprises transmitting data of the profile from the terminal management system to the secure element of the device and configuring the uploaded payment acceptance applet on the secure element with the transmitted data. The payment acceptance applet may be selected among a plurality of payment acceptance applets based on the specific execution environment of the payment terminal.

### TECHNICAL FIELD

The present disclosure relates to the field of devices with a payment terminal functionality for performing secured financial transactions. More specifically, the present disclosure relates to a method and a terminal management system for managing a device used as a payment terminal and comprising a secure element.

### BACKGROUND

Merchants often use dedicated payment terminals to conduct secured financial transactions with customers. Such customers usually hold payment cards issued by a financial institution or a payment card institution. In some instances, the payment cards include a magnetic strip and/or a smart card chip allowing a transaction to be initiated by swiping the card in a magnetic strip reader of a dedicated payment terminal or by introducing the payment card in a smart card reader of a dedicated payment terminal. In other instances, the payment card may also be contactless transaction enabled to allow a transaction to occur by presenting the payment card proximate to a dedicated payment terminal. In order to ensure security during the financial transactions, security standards such as the Europay MasterCard Visa (EMV) transaction standard have been developed and used to certify both the dedicated payment terminals and the payment cards.

In order to provide more flexibility and develop new business models, devices initially not dedicated to implement a payment terminal functionality are now used. For example, such devices may include mobile computing devices (e.g. smartphones, tablets). Such a device includes a security element, capable of executing a dedicated payment application for conducting a secured financial transaction. In order to provide the appropriate level of security, the payment terminal functionality supported by the secure element is compliant with the appropriate security standard, for instance EMV.

The payment terminal functionality may be deployed on a large scale, involving multiple devices each providing the payment terminal functionality. These devices may be deployed over a large geographic area, may be used by a plurality of different merchants, and may interact with several different financial institutions. This complex payment infrastructure needs to be managed in a secure and efficient way.

There is therefore a need for a method and system for managing a device with a secure element used as a payment terminal.

### SUMMARY

According to an aspect, the present disclosure relates to a method for managing a device used as a payment terminal and comprising a secure element. The method comprises generating a profile of the payment terminal on a terminal management system, based on a specific execution environment of the payment terminal. The method comprises uploading a payment acceptance applet on the secure element of the device. The method also comprises transmitting data of the profile from the terminal management system to the secure element of the device. The method further comprises configuring the uploaded payment acceptance applet on the secure element with the transmitted data. The payment acceptance applet may be selected among a plurality of payment acceptance applets, based on the specific execution environment of the payment terminal.

According to another aspect, the present disclosure relates to a terminal management system for managing a device used as a payment terminal and comprising a secure element. The terminal management system comprises a processing unit for generating a profile of the payment terminal, based on a specific execution environment of the payment terminal. The terminal management system also comprises memory for storing the profile and a payment acceptance applet. The terminal management system further comprises a communication interface for transmitting the payment acceptance applet to the secure element of the device, and transmitting data of the profile to the secure element of the device. The payment acceptance applet may be selected among a plurality of payment acceptance applets, based on the specific execution environment of the payment terminal.

In a particular aspect, the specific execution environment of the payment terminal comprises at least one of the following: a specific hardware or software configuration of the secure element, a specific hardware or software configuration of the device, a specific geographical area, a specific merchant using the payment terminal, a specific payment brand supported by the payment terminal, a specific financial institution accepting a transaction from the payment terminal.

The foregoing and other features of the present method, payment terminal system and device will become more apparent upon reading of the following non-restrictive description of illustrative embodiments thereof, given by way of example only with references to the accompanying drawings.

### BRIEF DESCRIPTION OF THE DRAWINGS

Embodiments of the disclosure will be described by way of examples only, with reference to the accompanying drawings, in which:

FIG. 1 illustrates a method for managing a device used as a payment terminal and comprising a secure element, according to a non-restrictive illustrative embodiment;

FIG. 2 illustrates a terminal management system for managing a device used as a payment terminal and comprising a secure element, according to a non-restrictive illustrative embodiment;

FIG. 3 illustrates functional components of a terminal management system, according to a non-restrictive illustrative embodiment; and

FIG. 4 illustrates an exemplary embodiment of a terminal management profile.

### DETAILED DESCRIPTION

The following terminology is used throughout the present disclosure, and is meant to be interpreted as follows:

Secure element: a processing entity characterized by specific hardware and/or software components subject to a certification ensuring a specific level of security according to specific security standards. From a hardware perspective, a secure element includes usual components found in a computing entity: at least one microcontroller (e.g. Central Processing Unit (CPU)), memory (e.g. Random Access Memory (RAM) or FLASH memory), communication interfaces, etc. Specific hardware components may also be included to implement specific functionalities particular to a secure element. For instance, a cryptographic accelerator may be included. Also, a module providing Radio Frequency (RF) and electrostatic insulation may be included, to protect the secure element from eavesdropping. In the context of financial transactions, the certification of the secure element ensures that various financial entities are willing to use the secure element to store and process critical financial data, and to perform secured financial transactions using the critical financial data.

Payment acceptance applet: a payment acceptance application executed by a secure element to conduct a secured financial transaction with an external entity (e.g. a financial institution such as a bank) for accepting a payment. The term applet is used since the operating system (OS) of the secure element generally consists in Java Card® from Oracle Inc. However, the payment application may consist of any software application executable by the OS of the secure element.

Payment applet: a payment application executed by a secure element to conduct a secured financial transaction with an external entity (e.g. a Point of Sale) for executing a payment.

Security keys: refers to any security material at large, including keys (e.g. authentication or encryption keys), certificates, security tokens, etc.

The present description discloses a method and a terminal management system for managing a device used as a payment terminal and comprising a secure element. More particularly, the present method and terminal management system allow the configuration of a payment acceptance applet uploaded on the secure element with data of a profile of the payment terminal.

Traditional payment terminals consist of dedicated terminals implementing Point of Sale (POS) functionality. The POS functionality comprises the execution of a dedicated payment acceptance applet by the terminal, for accepting a payment made via a credit card, a device with payment capabilities (e.g. a smartphone), etc. The payment terminal stores a dedicated profile for the POS functionality. Information of the dedicated profile are generated by a Terminal Management System (TMS) and transmitted by the TMS to the payment terminal. A fleet of dedicated payment terminals managed by a TMS is generally homogeneous. An execution environment of the managed payment terminals is substantially the same for all the managed payment terminals, and consequently the dedicated profiles are substantially the same for all the managed payment terminals. Additionally, the managed payment terminals may upload the dedicated payment acceptance applet from the TMS, the dedicated payment acceptance applet being also substantially the same for all the managed payment terminals.

Mobile devices (such as smartphones) are now used in addition to traditional credit cards for executing a payment transaction. Such mobile devices include a secure element for emulating a credit card functionality and securely executing a payment applet for executing the payment transaction. The secure element communicates with a payment terminal (implementing a POS functionality) for executing the payment transaction, for example by means of the Near Field Communication (NFC) protocol (in this case, both the mobile device and the payment terminal include NFC communication capabilities). The mobile device stores a dedicated profile for the payment application and a dedicated profile for the secure element. Information of the dedicated profiles are generated by a Trusted Service Manager (TSM) and transmitted by the TSM to the mobile device.

The present disclosure describes a mobile device including a secure element, which has been adapted to implement POS functionality, in order to be used as a payment terminal (receive and process a payment transaction). For this purpose, the secure element is capable of executing a payment acceptance applet. A profile is stored on the POS mobile device, comprising information related to the payment acceptance applet, to the secure element, etc. A TMS is used to generate information of the profile and to transmit the information to the POS mobile terminal. The TMS combines functionalities of a traditional TMS for managing a traditional POS terminal and functionalities of a TSM for managing a mobile device with a secure element capable of executing a payment transaction. However, due to the heterogeneity of the execution environments of the payment terminals implemented by each specific mobile device, the profiles generated by the TMS need to be adapted for each specific mobile device.

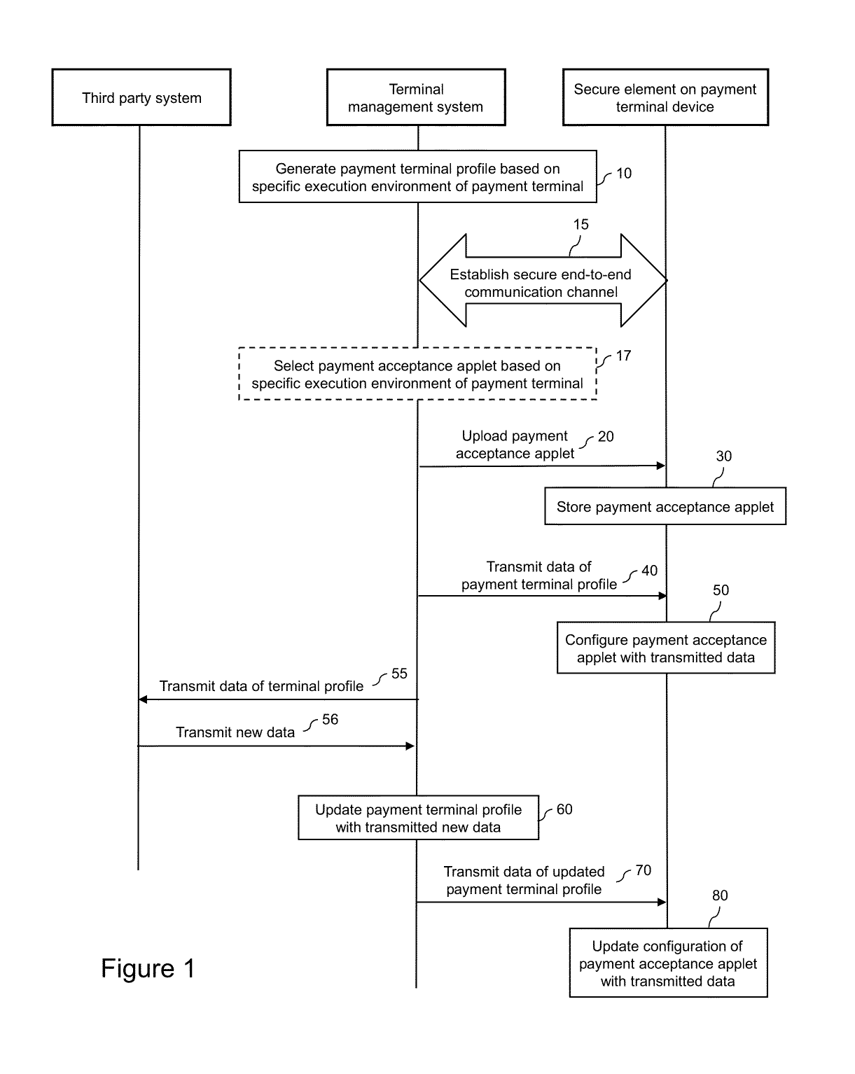

Reference is now made to FIG. 1, which represents a method for managing a device used as a payment terminal and comprising a secure element. As mentioned previously, the device may be any type of device (e.g. a mobile computing device such as a smartphone or a tablet) incorporating a secure element. The payment terminal functionality of the device is provided by the secure element, which is capable of executing a payment acceptance applet for conducting a secured financial transaction. Other components (hardware and/or software) of the device may also contribute to the payment terminal functionality.

The method comprises generating 10 a profile of the payment terminal on a terminal management system. The profile is generated based on a specific execution environment of the payment terminal. The terminal management system is a computing system in charge of managing at least one (and generally a plurality of) device(s) implementing a payment terminal functionality. The profile of the payment terminal includes data related to the implementation of the terminal functionality on the device.

The method also comprises uploading 20 a payment acceptance applet on the secure element of the device. The payment acceptance applet may be uploaded by the payment terminal system, as illustrated in FIG. 1. Alternatively, the payment acceptance applet is uploaded by a third party system (e.g. a financial institution, a Trusted Service Manager (TSM), a Payment Service Provider (PSP), an acquirer). The payment acceptance applet is stored 30 on the secure element of the device, for instance in a memory. Before performing the upload 20, the payment acceptance applet is selected 17 among a plurality of payment acceptance applets, based on the specific execution environment of the payment terminal.

The method further comprises transmitting 40 data of the payment terminal profile from the terminal management system to the secure element of the device.

Then, the method comprises configuring 50 the uploaded payment acceptance applet on the secure element with the transmitted data.

The terminal management system is capable of managing several devices with a secure element, each device having its own payment terminal profile. For this purpose, several specific profiles are generated 10, each specific profile corresponding to a payment terminal of a specific device. Each specific profile is generated based on the specific execution environment of the payment terminal of the corresponding specific device. A payment acceptance applet is uploaded 20 on the secure element of each specific device. Data of each specific profile are transmitted 40 to the secure element of the specific device corresponding to the specific profile. The uploaded payment acceptance applet on the secure element of each specific device is configured 50 with the transmitted data. The payment acceptance applet may be the same for all the specific devices, or different payment acceptance applets may be used by the plurality of specific devices. In the latter case, the payment acceptance applet for each specific device is selected among a plurality of payment acceptance applets, based on the specific execution environment of the payment terminal of each device.

The selection of the specific execution environment of the payment terminal is based on at least one of the following: a specific hardware or software configuration of the secure element, a specific hardware or software configuration of the device, a specific geographical area, a specific merchant using the payment terminal, a specific payment brand supported by the payment terminal, a specific financial institution accepting a transaction from the payment terminal, etc.

The configuration of the payment acceptance applet with the transmitted data of the profile allows the payment acceptance applet to take into account the specific environment in which it is executed. For instance, a generic payment acceptance applet may be uploaded on the secure element of multiple devices, and adapted to a specific usage and a specific environment on each secure element, using the transmitted data to configure it for the specific usage and environment.

In a first example, the generated profile takes into consideration a specific form factor of the secure element of the mobile device (e.g. Subscriber Identification Module (SIM) card or Micro Secure Digital (SD) card). In another example, the generated profile takes into consideration a specific form factor of the mobile device. For instance, the presence or not of a physical keyboard on the mobile device, the presence or not of a touchscreen, determines how the payment acceptance applet receives a Personal Identification Number (PIN) for validating a transaction by a customer. In the case of NFC enabled transactions, the secure element may be capable of interacting directly with a NFC controller of the mobile device (via a direct hardware link). Alternatively, the secure element communicates with the NFC controller via a relay. The configuration of the payment acceptance applet is different in the two alternatives, in particular for addressing specific security issues raised by the usage of NFC communications. In a third example, the generated profile takes into consideration a geographical area where the mobile device is used. For instance, in North America, only on-line transactions (a financial transaction validated by a financial institution) are authorized, while in Europe both on-line and off-line transactions (a financial transaction which does not need to be validated by a financial institution, for example if the amount is lower than a pre-defined threshold) are authorized. Additionally, specific payment brands could be used or not, based on the geographical area (e.g. Visa® or MasterCard® are not supported/authorized in particular countries). In a fourth example, the generated profile takes into consideration the type of merchant using the mobile device as a payment terminal. For instance, the size of the merchant, the financial power of the merchant, the type of business carried out by the merchant, etc. determines a configuration of the payment acceptance applet, in order to authorize or prevent a particular type of financial transaction (e.g. financial transactions limited to a pre-defined maximum amount).

Additionally, as mentioned previously, the payment acceptance applet may be selected among a plurality of applets (stored by the TMS) to adapt to the specific execution environment of the payment terminal of a specific mobile device. For example, based on the hardware and software configuration of the secure element (e.g. processing power, available memory, operating system, etc.), a particular applet capable of supporting this configuration is selected. Furthermore, the TMS can manage a plurality of merchants, each merchant having its own payment acceptance applet(s). Thus, for each specific mobile device, based on the particular merchant using the mobile device as a payment terminal, a specific applet is selected (and a specific profile is generated for this specific applet). A single mobile device can also have more than one payment acceptance applet (to implement a plurality of payment terminals on the same mobile device). Each of the payment acceptance applets is selected by the TMS to support one of the plurality of payment terminals (the TMS also generates a specific payment terminal profile for each of the selected applets). For instance, there may be a dedicated payment acceptance applet and a corresponding payment terminal profile for each particular financial institution supported by the mobile device used as a POS.

The profile of the payment terminal may comprise data related to the payment terminal, data related to the device, data related to the secure element, data related to the payment acceptance applet, data related to activated payment brands, data related to security keys used by the secure element or the payment acceptance applet, data related to a merchant, etc. The security keys are used to provide a secure environment for conducting a secured financial transaction by executing the payment acceptance applet on the secure element. For example, an end-to-end secure communication channel may be established between the secure element and a financial institution for conduction the secured financial transaction. The merchant is the commercial entity using the device as a payment terminal for allowing customers to pay for goods or services. Examples of the various types of data stored in the profile of the payment terminal will be detailed later in the description.

In order to provide a satisfactory level of security for the transmission of data between the terminal management system and the secure element on the device, an end-to-end secure communication channel is established 15 between these two entities. Security credentials (e.g. keys, certificates) present on at least one of the terminal management system and the secure element may be used for the establishment of the secure communication channel.

When the device is a mobile computing device, it communicates with other entities via a mobile communication infrastructure, for example a cellular network or a Wireless Local Area Network (WLAN) network. Data of the profile may be transmitted from the terminal management system to the secure element of the device over the secure communication channel according to an Over The Air protocol. Similarly, the payment acceptance applet may be transmitted from the terminal management system to the secure element of the device over the secure communication channel according to an Over The Air protocol. Alternatively, a proximity contactless protocol can be used, as will be illustrated later in the description

The profile of the payment terminal is stored on the terminal management system. Over time, the environment and the usage of the payment acceptance applet on the secure element may evolve. To take this evolution into account, the present method may also comprise: updating 60 the payment terminal profile on the terminal management system, transmitting 70 data of the updated profile from the terminal management system to the secure element of the device, and updating 80 the configuration of the payment acceptance applet on the secure element with the transmitted data.

The terminal management system may also interact with a third party system, for example a server of one of: a financial institution, a merchant, a Trusted Service Manager (TSM), a Payment Service Provider (PSP), an acquirer. For instance, data of the payment terminal profile may be transmitted 55 from the terminal management system to the third party system. These data may be used for monitoring the deployment of the payment acceptance applet on multiple devices used as payment terminals, and for monitoring the operational parameters of the payment acceptance applets. Additionally, data may be transmitted 56 from the third party system to the terminal management system, processed by the terminal management system, and the payment terminal profile updated 60 with the processed data.

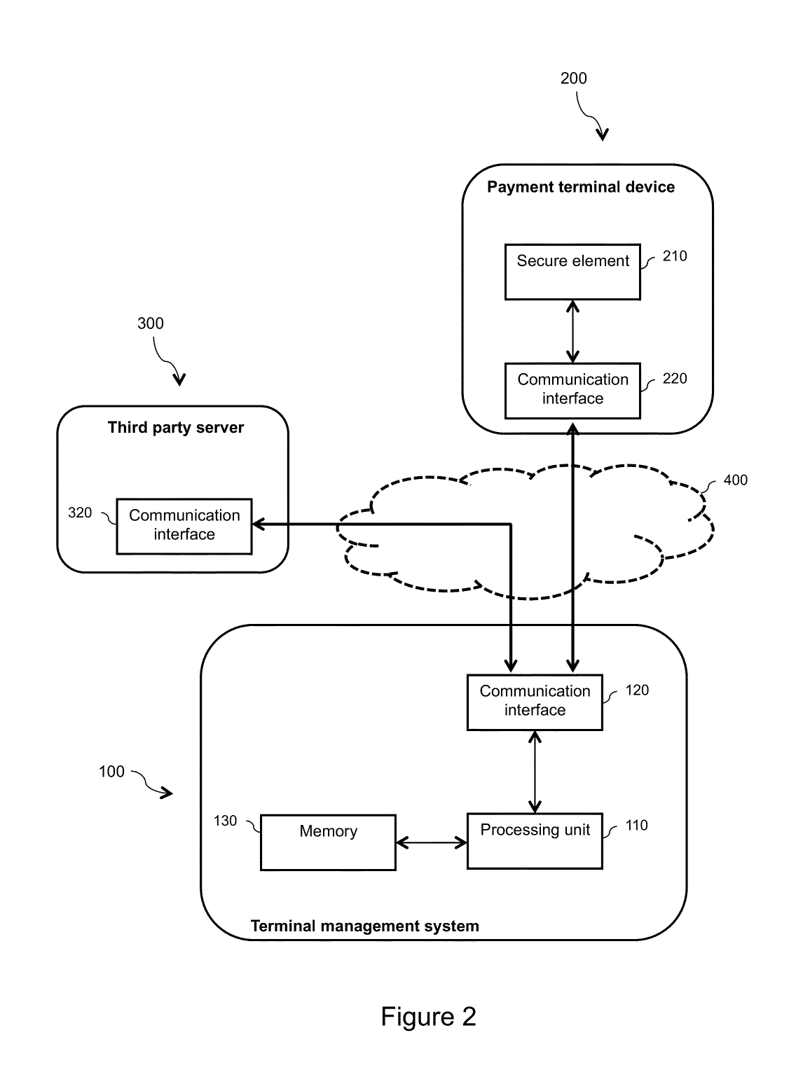

Reference is now made to FIG. 2, which represents a terminal management system 100 for managing a device 200 used as a payment terminal and comprising a secure element 210.

The terminal management system 100 comprises a processing unit 110 for generating a profile of the payment terminal. The profile is generated based on a specific execution environment of the payment terminal.

The terminal management system 100 comprises memory 130 for storing the payment terminal profile and a payment acceptance applet for the payment terminal. The processing unit 110 may select the payment acceptance applet among a plurality of payment acceptance applets, based on the specific execution environment of the payment terminal.

The terminal management system 100 comprises a communication interface 120 for transmitting the payment acceptance applet and data of the payment terminal profile to the secure element 210 of the device 200 used as a payment terminal. Then, the secure element 210 configures the received payment acceptance applet with the received data of the payment terminal profile.

The device 200 also comprises a communication interface 220. The communication interfaces 120 and 220 allow communications between the terminal management system 100 and the device 200 over a communication network 400. The communication network 400 may consist of a mobile communication network or a fixed communication network.

The processing unit 110 establishes an end-to-end secure communication channel between the terminal management system 100 and the secure element 210 of the device 200. The end-to-end secure communication channel allows secure transmission of data over the communication network 400 between the communication interfaces 120 and 220, as well as between the communication interface 220 and the secure element 210 within the device 200.

In the case where the device 200 is a mobile computing device, the communication network 400 is a mobile communication network such as a cellular network or a WLAN network. The payment acceptance applet and data of the payment terminal profile are transmitted by the communication interface 120 to the secure element 210 of the device 200 over the secure communication channel according to an Over The Air protocol. Alternatively, a proximity contactless protocol can be used.

The communication interface 120 may also transmit data of the payment profile to a third party system 300 (e.g. a financial institution). Additionally, the communication interface 120 may receive data from the third party system 300, and the processing unit 110 may process the received data and update the payment terminal profile with the processed data.

The third party server 300 comprises a communication interface 320 for exchanging data with the communication interface 120 of the terminal management system 100 over the communication network 400. Alternatively, the third party server 300 may communicate with the terminal management system 100 over a first communication network (e.g. a fixed network), and the payment terminal device 200 may communicate with the terminal management system 100 over a second different network (e.g. a mobile network).

In an alternative embodiment, the payment acceptance applet is not stored on the terminal management system 100 and uploaded on the secure element 210 of the device 200 by the terminal management system 100. For example, the third party server 300 may be in charge of storing the payment acceptance applet and uploading it on the secure element 210 of the device 200.

The terminal management system 100 comprises hardware and software executed by the hardware for implementing its functionalities. For instance, the processing unit 110 comprises at least one processor capable of executing at least one dedicated software for implementing the functionalities of the processing unit 110. Similarly, the communication interface 120 and the memory 130 may comprise dedicated software executed either by a dedicated processor or by a processor of the processing unit 110.

The terminal management system 100 may be implemented to provide a Software as a Service (Saas) to the device 200. Also, several terminal management systems 100 may be deployed in a geo-redundant manner to support a plurality of devices 200 located on a large territory.

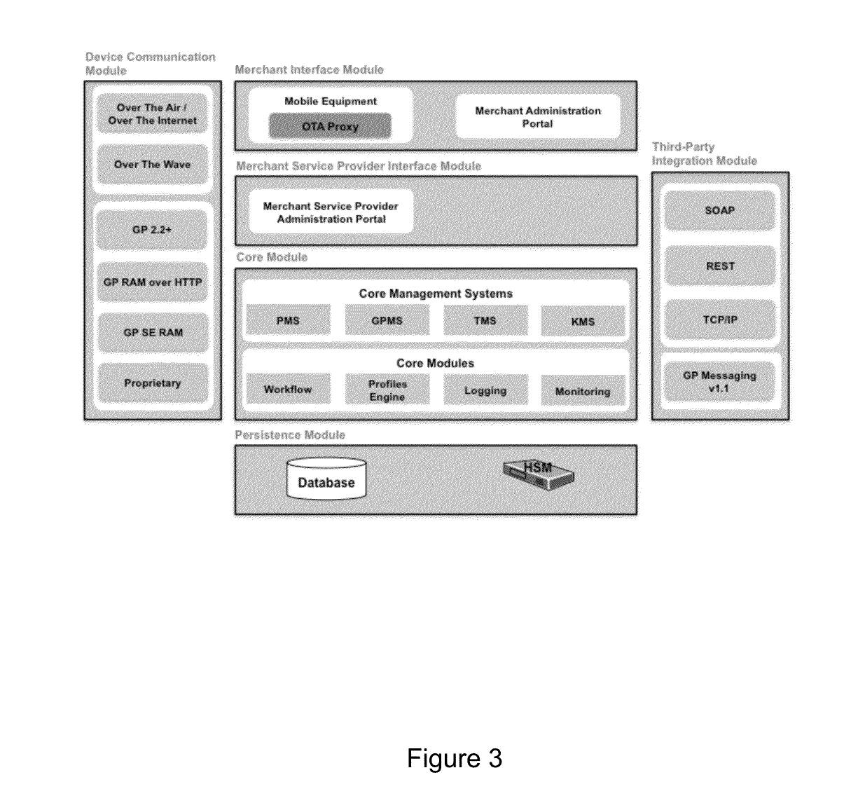

Reference is now made concurrently to FIGS. 2 and 3, where FIG. 3 represents functional components of a terminal management system.

Most of the components represented in FIG. 3 may be implemented by the processing unit 110 of the terminal management system 100 represented in FIG. 2; while some components may be partially or fully implemented by the communication interface 120 and the memory 130 respectively. Those of ordinary skill in the art will readily appreciate that the entities (components, modules and sub-modules) represented in FIG. 3 are exemplary and are not intended to limit the present disclosure. In particular, some entities represented in FIG. 3 may be omitted, while other entities not represented in FIG. 3 may be included, in a terminal management system.

The terminal management system illustrated in FIG. 3 comprises the following functional components: a Core Module, a Persistence Module, a Third-Party Integration Module, a Device Communication Module, a Merchant Interface Module, and a Merchant Service Provider Interface Module. The functional components may include a combination of hardware and software components. These functional components may, for example, be implemented by several dedicated software modules executed by the processing unit 110.

### Core Module

The Core Module represented in FIG. 3 comprises eight sub-modules: Profile Management System (PMS), Monitoring, GlobalPlatform Management System (GPMS), Terminal Management System (TMS), Key Management System (KMS), Workflow, Profiles Engine, Logging and Monitoring.

The Profile Management System is responsible for generating and updating the profiles of the payment terminals. Each payment terminal profile comprises data related to the payment terminal, and may contain one or several of the following sub-profiles: a profile of the device implementing the payment terminal, a profile of the secure element of the device, a profile of a payment acceptance applet to be uploaded on and executed by the secure element, a profile of the security keys used by the secure element and the payment acceptance applet, a profile of a merchant with which the payment acceptance applet can perform a secured financial transaction, etc. Each profile and sub-profile has its own lifecycle.

The profiles of the secure element, payment acceptance applet and security keys are compliant with GlobalPlatform Systems Profiles specifications.

The profiles of the mobile device and merchant are proprietary, but may follow guidelines of the GlobalPlatform Systems Profiles specifications. The profile of the payment terminal is also proprietary.

The GlobalPlatform Management System (GPMS) manages the content of the secure element of the device.

In a particular embodiment, the GPMS is compliant with GlobalPlatform Card Specifications, and more specifically with version 2.2.2 and higher. The GPMS is also compliant with Secure Channel Protocol (SCP) 02 and SCP 02 security levels Authenticated, Integrity and Confidentiality.

The GPMS establishes an end-to-end secure communication channel with the secure element of the device. Furthermore, data exchanged over the secure communication channel (e.g. the payment acceptance applet or data of the payment terminal profile) may be transmitted according to an Over The Air (OTA) protocol, an Over The Internet protocol or an Other The Wave protocol. These protocols will be described later in the description.

The Terminal Management System (TMS) manages the generation of a payment terminal and of its associated profile. The generation of the profile is performed in collaboration with the Profile Management module, while the generation of the payment terminal is performed in collaboration with the GPMS (upload of the payment acceptance applet and data of the profile on the secure element).

Data associated to a payment terminal and stored in its profile include: card type supported, transaction type supported, IP address of the device, Bank Identification Number (BIN) range supported, transaction amount limits, etc.

Data stored in the merchant sub-profile include: profile information, merchant name and address, merchant language, merchant ID, merchant category code, etc.

Data stored in the device sub-profile include: profile information, device parameters (CPU architecture, Near Field Communication (NFC), NFC Controller type and architecture, antenna location, keyboard type, Events, secure element, Bearer Independent Protocol (BIP), Supported Push), etc.

Data stored in the secure element sub-profile include: profile information, manufacturer, platform, chipset, resources available, bearer available, application instances, load file instances, etc.

Data stored in the payment acceptance applet sub-profile include: profile information, applet version, kernels supported, load file, module Application Identifier (AID), application AID, instance AID, installation parameters, Electrically Erasable Programmable Read-Only Memory (EEPROM) size, RAM size, etc. It may also include the payment brands (e.g. Visa®, MasterCard®, etc.) supported by the payment acceptance applet, and which of these payment brands are currently activated. A payment acceptance applet may be capable of supporting several payment brands, but can be configured to support only a subset of them. The security keys to be used with a particular payment brand are stored in the security keys sub-profile.

Data stored in the security keys sub-profile include: key types, key sizes, key usages, etc.

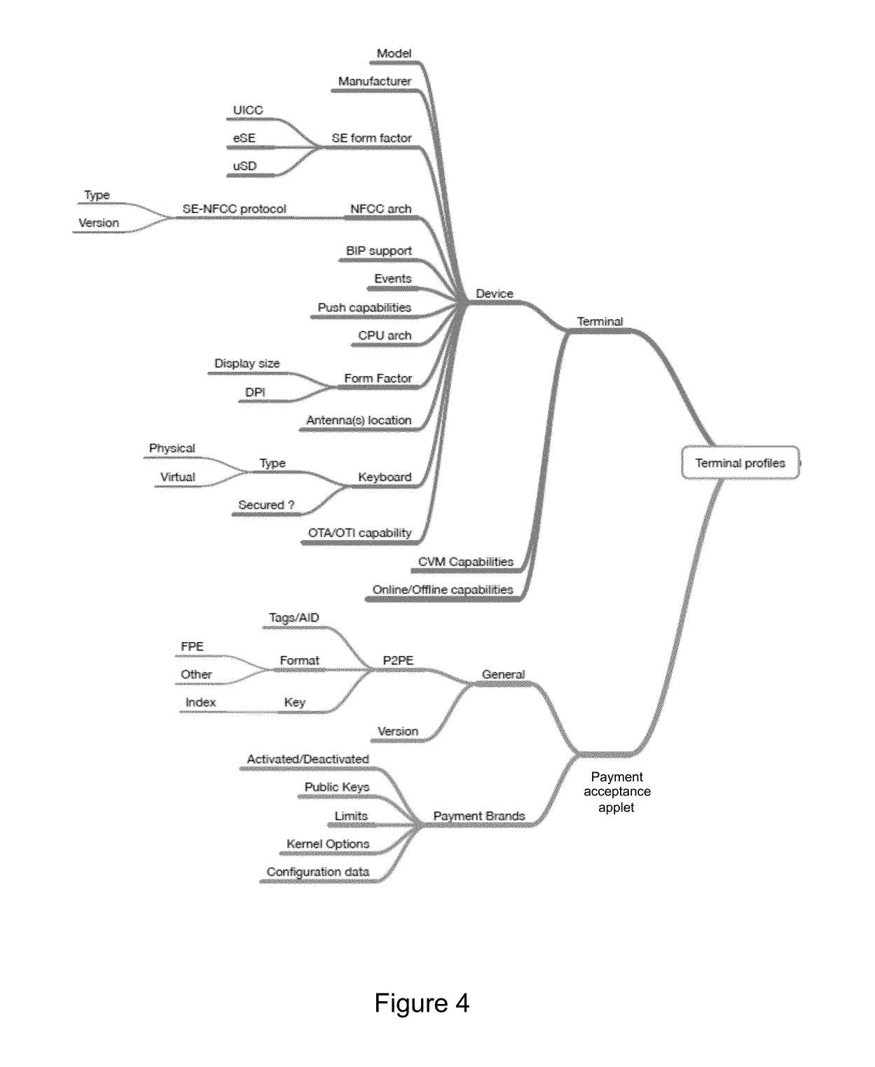

FIG. 4 illustrates an exemplary embodiment of a terminal profile and its sub-profiles.

The TMS interacts with the Persistence Module for persistent data storage.

The Key Management System (KMS) manages the security keys used by the secure element and the payment acceptance applet. The security keys may be used in the context of Secure Element Security Domains, Europay MasterCard Visa (EMV) transactions standard (Static Data Authentication (SDA), Dynamic Data Authentication (DDA), Combined Dynamic Data Authentication/Application Cryptogram (CDA), message authentication, application specific), Personal Identification Number (PIN) encryption. The types of security keys supported by the KMS include DES, 3DES, AES and RSA.

The Workflow Engine manages the initiation, execution and activity logging of the tasks executed by the Core Module. These tasks support both synchronous and asynchronous execution modes.

The Profiles Engine manages the parsing of the profiles, ensures they are properly formatted, instantiates the corresponding objects in the system in order to provide the Workflow Engine with the profile data.

The Logging sub-module logs events with indications of their level and severity.

The Monitoring sub-module provides functionalities for service monitoring, such as service statistics, resources statistics (e.g. CPU, memory, disk, network), request statistics (e.g. load, delete, lock, unlock, activate, . . . ), response times, error reports.

### Persistence Module

The Persistence Module represented in FIG. 3 comprises two sub-modules: a database and a Hardware Security Module (HSM).

The Persistence Module stores the profile of the payment terminal in the database. The payment acceptance applet may also be stored in the database.

The Persistence Module stores elements of the KMS in the database. The Hardware Security Module (HSM) cooperates with the KMS for storing security keys of the KMS. The Persistence Module may also operate without an HSM.

The Persistence Module prevents loss of data, provides redundancy and provides a backup mechanism. A DataBase Management System (DBMS) may be used to implement the Persistence Module.

### Third-Party Integration Module

The Third-Party Integration Module represented in FIG. 3 allows the terminal management system to connect to third parties systems. Various modes of communication are supported, including synchronous and asynchronous calls and notifications. The following communication protocols may be implemented: Simple Object Access Protocol (SOAP), Representational State Transfer (REST), Transmission Control Protocol/Internet Protocol (TCP/IP), GlobalPlatform Messaging specifications (and more specifically version 1.1).

### Device Communication Module

The Device Communication Module establishes an end-to-end secure communication channel with the secure element of the device. Data exchanged over the secure communication channel may be transmitted according to an Over The Air (OTA) or an Over The Internet protocol. The OTA protocol is a standard protocol initially developed by the telecommunication industry for remotely managing Subscriber Identity Module (SIM) cards on mobile phones. The OTI protocol is generally a proprietary protocol (although some standards exist) dedicated to the remote management of functionalities of mobile phones. The OTA and OTI protocols provide a similar capability: remote configuration and management of hardware and/or software components of a mobile device via a mobile communication network (e.g. a cellular network, a Wi-Fi network, etc).

Data exchanged over the secure communication channel may also be transmitted according to an Over The Wave protocol. The Over The Wave protocol is a proprietary protocol allowing proximity contactless (e.g. NFC) communications between two entities. In this case, the TMS 100 of FIG. 2 may be implemented by a tablet (having NFC communication capabilities) and communicating with the payment terminal device 200 of FIG. 2 (also having NFC communication capabilities) via the Over The Wave protocol. The TMS 100 and the payment terminal device 200 need to be close to one another to use the Over The Wave protocol.

The Device Communication Module also implements GlobalPlatform Remote Application Management (GP RAM) specifications for communicating with the secure element (SE) (GP RAM over HTTP and GP SE RAM). The Device Communication Module may also implement Proprietary communications protocols for communicating with the secure element. The Device Communication Module may further implement at least one Push mechanism, for instance Google Cloud Messaging for Android, BlackBerry Push Service, Apple Push Notification Service.

### Merchant Interface Module

The Merchant Interface Module provides administration functionalities to administrate the terminal management system. The Merchant Interface Module includes an OTA Proxy sub-module to provide secure communications with the secure element of the device and a Merchant Administration Portal sub-module to implement the administration functionalities.

The following functionalities are supported by the Merchant Interface Module: secure element information retrieval, payment acceptance applet information retrieval, mobile device information retrieval, payment terminal information retrieval, merchant information retrieval.

The Merchant Interface Module also provides the following functionalities: management of the profile of the payment terminal (and of its sub-profiles), management of the configuration of the terminal management system (lifecycle states, workflow, errors . . . ), and reporting/logging.

### Merchant Service Provider Interface Module

The Merchant Service Provider Interface Module provides a Merchant Service Provider Administration Portal for the administration of the Merchant Service Provider's account into the system and the administration of the Merchant Service Provider's device fleet. The administration of the device comprises, but is not limited to, the installation, activation, personalization, deactivation, reconfiguration, upgrade and removal of the payment acceptance applet onto the device secure element.

As illustrated in the previous description of the various components and modules of the terminal management system, security is a critical issue. The terminal management system needs to be compliant with several security standards; and may also need to be certified by certification authorities regulating the implementation and deployment of payment infrastructures.

In one embodiment, the terminal management system is compliant with at least some of the following standards: GlobalPlatform Secure Channel Protocol (and more specifically version 02), GlobalPlatform Key Management System, Organization for the Advancement of Structure Information Standards (OASIS) Web Services Security (and more specifically version 1.1).

In another embodiment, the terminal management system manages security keys of a Security Domain hosting the payment acceptance applet and data of the payment terminal profile on the secure element of the device, and the lifecycle of the Security Domain.

In still another embodiment, the terminal management system comprises a Key Management System (KMS), and the KMS is compliant with at least some of the following standards: Federal Information Processing Standard (FIPS) 140-2, Payment Card Industry Data Security Standard (PCI DSS) section 3.6, GlobalPlatform KMS specification, American National Standards Institute (ANSI) X9.24 for the management of Derived Unique Key Per Transaction (DUKPT) keys used by the payment acceptance applet for Point to Point Encryption (P2PE). Furthermore, the KMS may use one of: a Hardware Security Module (HSM) for storing the security keys or a Key Encryption Key system for storing the security keys in a database of the terminal management system.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for managing a device used as a payment terminal and comprising a secure element, the method comprising:
generating a profile of the payment terminal on a terminal management system based on a specific execution environment of the payment terminal;
uploading a payment acceptance applet on the secure element of the device;
transmitting data of the profile from the terminal management system to the secure element of the device; and
configuring the uploaded payment acceptance applet on the secure element with the transmitted data.

2. The method of claim 1, wherein the payment acceptance applet is selected among a plurality of payment acceptance applets based on the specific execution environment of the payment terminal.

3. The method of claim 1, wherein the specific execution environment of the payment terminal comprises at least one of the following: a specific hardware or software configuration of the secure element, a specific hardware or software configuration of the device, a specific geographical area, a specific merchant using the payment terminal, a specific payment brand supported by the payment terminal, a specific financial institution accepting a transaction from the payment terminal.

4. The method of claim 1, wherein the payment acceptance applet is uploaded by the terminal management system.

5. The method of claim 4, further comprising activation, deactivation, reconfiguration, upgrade and removal of the payment acceptance applet on the device secure element by the terminal management system.

6. The method of claim 1, wherein the profile of the payment terminal comprises at least one of:
data related to the payment terminal;
data related to the device;
data related to the secure element;
data related to the payment acceptance applet;
data related to activated payment brands;
data related to security keys used by the secure element or the payment acceptance applet; and
data related to a merchant.

7. The method of claim 1 further comprising:
opening an end-to-end secure communication channel between the terminal management system and the secure element of the device.

8. The method of claim 7 further comprising:
transmitting data of the profile from the terminal management system to the secure element of the device over the secure communication channel according to one of the following: an Over The Air protocol or a proximity contactless protocol.

9. The method of claim 7 further comprising:
transmitting the payment acceptance applet from the terminal management system to the secure element of the device over the secure communication channel according to one of the following: an Over The Air protocol or a proximity contactless protocol.

10. The method of claim 1 further comprising:
updating the profile on the terminal management system;
transmitting data of the updated profile from the terminal management system to the secure element of the device; and
updating the configuration of the payment acceptance applet on the secure element with the transmitted data.

11. The method of claim 1, wherein:
several specific profiles are generated, each specific profile corresponding to a payment terminal of a specific device;
a payment acceptance applet is uploaded on the secure element of each specific device;
data of each specific profile are transmitted to the secure element of the specific device corresponding to the specific profile; and
the uploaded payment acceptance applet on the secure element of each specific device is configured with the transmitted data.

12. The method of claim 11, wherein the uploaded payment acceptance applet has been selected among a plurality of payment acceptance applets based on the specific execution environment of the payment terminal of each specific device.

13. A terminal management system for managing a device used as a payment terminal and comprising a secure element, the terminal management system comprising:
a processing unit for:
generating a profile of the payment terminal based on a specific execution environment of the payment terminal;
memory for:
storing the profile and a payment acceptance applet; and
a communication interface for:
transmitting the payment acceptance applet to the secure element of the device; and
transmitting data of the profile to the secure element of the device.

14. The system of claim 13, wherein the payment acceptance applet is selected by the processing unit among a plurality of payment acceptance applets based on the specific execution environment of the payment terminal.

15. The system of claim 13, wherein the specific execution environment of the payment terminal comprises at least one of the following: a specific hardware or software configuration of the secure element, a specific hardware or software configuration of the device, a specific geographical area, a specific merchant using the payment terminal, a specific payment brand supported by the payment terminal, a specific financial institution accepting a transaction from the payment terminal.

16. The system of claim 13, wherein the profile of the payment terminal comprises at least one of:
data related to the payment terminal;
data related to the device;
data related to the secure element;
data related to the payment acceptance applet;
data related to activated payment brands;
data related to security keys used by the secure element or the payment acceptance applet; and
data related to a merchant.

17. The system of claim 13, wherein the processing unit establishes an end-to-end secure communication channel between the terminal management system and the secure element of the device.

18. The system of claim 17, wherein the payment acceptance applet and data of the profile are transmitted by the communication interface to the secure element of the device over the secure communication channel according to one of the following: an Over The Air protocol or a proximity contactless protocol.

19. The system of claim 13, wherein:
the processing unit:
generates several specific profiles, each specific profile corresponding to a payment terminal of a specific device;
the memory:
stores the several specific profiles; and
the communication interface:
transmits a payment acceptance applet to the secure element of each specific device; and
transmits data of each specific profile to the secure element of the specific device corresponding to the specific profile.

20. The system of claim 19, wherein the transmitted payment acceptance applet has been selected among a plurality of payment acceptance applets based on the specific execution environment of the payment terminal of each specific device.
